(19) United States
(12) Patent Application Publication
(10) Pub. No.: US 2024/0362498 A1
(43) Pub. Date: Oct. 31, 2024

(54) SOLVER DEVICES AND METHODS

(71) Applicant: INTERNATIONAL BUSINESS MACHINES CORPORATION, ARMONK, NY (US)

(72) Inventors: Rahul Nair, Dublin (IE); Radu Marinescu, Dublin (IE); Ambrish Rawat, Dublin (IE); Daniel Karl I. Weidele, Cambridge, MA (US)

(21) Appl. No.: 18/309,625

(22) Filed: Apr. 28, 2023

(51) Int. Cl. G06N 5/01

(52) U.S. Cl. CPC G06N 5/013

(57) ABSTRACT

A system includes an agent engine, an encoder, a general-purpose solver engine, and an orchestrator. The orchestrator is configured to receive a first problem instance corresponding to a learned policy that is based on auto reinforcement learning, and provide the first problem instance to the general-purpose solver engine, which is configured to execute based on the first problem instance to determine a solver state. The orchestrator is configured to extract, from the general-purpose solver engine, the solver state, and to provide the solver state to the encoder. The encoder is configured to query the agent engine for a best action according to the learned policy and an encoded solver state. The agent engine is configured to determine the best action according to the learned policy and the encoded solver state. The orchestrator is configured to receive the best action, and direct the general-purpose solver to implement the best action.

### BACKGROUND

Decision optimization seeks to optimize metrics through a formulation of objectives, constraints, and variables (decisions) which are then solved to determine the optimal decision in this setting. Example of decision optimization include: inventory management (e.g., a decision is how much stock to order at any given time); supply chain (e.g., a decision is how to fulfill some orders); and logistics (e.g., a decision is how to route vehicles to service deliveries).

The typical work flow in this setting includes determining a business problem specification (e.g., what to optimize, what key performance indicators (KPIs) to consider, what is the decision space, how often, and are all factors known or uncertain). The work flow also includes an operations research specialist defines a mathematical formulation (e.g., how can the problem be modeled in terms of constraints, variables and objectives). The work flow also includes the specialist working with data providers to implement a model/solution using existing solvers. The work flow also includes evaluating the model/solution to determine how well the metrics can be improved. The work flow also includes iteratively refining the model/solution until the model/solution can be deployed for use.

However, non-experts do not have the ability of adjust optimization models, existing solvers have a large configuration space (hundreds of parameters) that is hard to tune for specific applications, and solvers make several choices during optimization that are driven by general-purpose heuristics aimed at broad applicability.

### SUMMARY

Embodiments of this disclosure include a system that includes an agent engine, an encoder, a general-purpose solver engine, and an orchestrator. The orchestrator is configured to receive a first problem instance corresponding to a learned policy that is based on auto reinforcement learning, and provide the first problem instance to the general-purpose solver engine, which is configured to execute based on the first problem instance to determine a solver state. The orchestrator is configured to extract, from the general-purpose solver engine, the solver state, and to provide the solver state to the encoder. The encoder is configured to query the agent engine for a best action according to the learned policy and an encoded solver state. The agent engine is configured to determine the best action according to the learned policy and the encoded solver state. The orchestrator is configured to receive the best action, and direct the general-purpose solver to implement the best action.

In some embodiments of the system, the best action corresponds to one or more branching policies.

In some embodiments of the system, the solver state includes a number of fixed variables and a depth of a search tree.

In some embodiments of the system, the learned policy is configured to use the number of fixed variables and the depth to establish one or more variables to branch on.

In some embodiments of the system, the one or more branching policies include the one or more variables.

In some embodiments of the system, the orchestrator is configured to direct the general-purpose solver to implement the best action comprises the orchestrator being configured to direct the general-purpose solver to branch on the one or more variables.

In some embodiments of the system, the system further includes an automated policy search engine configured to receive rollout data from the encoder, determine the learned policy using the rollout data and via offline learning, and provide the learned policy to the agent engine.

Embodiments of this disclosure include a computer-implemented method that includes: receiving, by an orchestrator, a first problem instance corresponding to a learned policy that is based on auto reinforcement learning; providing, by the orchestrator, the first problem instance to a general-purpose solver engine; executing, by the general-purpose solver engine, based on the first problem instance to determine a solver state; extracting, by the orchestrator and from the general-purpose solver engine, the solver state; providing, by the orchestrator and to an encoder, the solver state; querying, by the encoder, the agent engine for a best action according to the learned policy and an encoded solver state; determining, by the agent engine, the best action according to the learned policy and the encoded solver state; receiving, by the orchestrator, the best action; and directing, by the orchestrator, the general-purpose solver engine to implement the best action.

In some embodiments of the computer-implemented method, the best action corresponds to one or more branching policies.

In some embodiments of the computer-implemented method, the solver state includes a number of fixed variables and a depth of a search tree.

In some embodiments of the computer-implemented method, the learned policy is configured to use the number of fixed variables and the depth to establish one or more variable to branch on.

In some embodiments of the computer-implemented method, the one or more branching policies comprise the one or more variables.

In some embodiments of the computer-implemented method, directing the general-purpose solver engine to implement the best action comprises the orchestrator directing the general-purpose solver engine to branch on the one or more variables.

In some embodiments of the computer-implemented method, the computer-implemented method further includes receiving, by an automated policy search engine, rollout data from the encoder; determining, by the automated policy search engine, the learned policy using the rollout data and via offline learning; and providing, by the automated policy search engine, the learned policy to the agent engine.

Embodiments of this disclosure include a non-transitory computer-readable medium storing instructions that when executed by one or more processors, cause a solver device to: receive, by an orchestrator of the solver device, a first problem instance corresponding to a learned policy that is based on auto reinforcement learning; provide, by the orchestrator, the first problem instance to a general-purpose solver engine of the solver device; execute, by the general-purpose solver engine, based on the first problem instance to determine a solver state; extract, by the orchestrator and from the general-purpose solver engine, the solver state; provide, by the orchestrator and to an encoder of the solver device, the solver state; query, by the encoder, the agent engine for a best action according to the learned policy and an encoded solver state; determine, by the agent engine, the best action according to the learned policy and the encoded solver state; receive, by the orchestrator, the best action; and direct, by the orchestrator, the general-purpose solver engine to implement the best action.

In some embodiments of the non-transitory computer-readable medium, the best action corresponds to one or more branching policies.

In some embodiments of the non-transitory computer-readable medium, the solver state comprises a number of fixed variables and a depth of a search tree.

In some embodiments of the non-transitory computer-readable medium, the learned policy is configured to use the number of fixed variables and the depth to establish one or more variable to branch on.

In some embodiments of the non-transitory computer-readable medium, the one or more branching policies comprise the one or more variables.

In some embodiments of the non-transitory computer-readable medium, when executed by the one or more processors, the instructions are configured to direct the general-purpose solver engine to implement the best action by causing the orchestrator to direct the general-purpose solver engine to branch on the one or more variables.

### BRIEF DESCRIPTION OF THE DRAWINGS

FIG. 1 is a block diagram view of an embodiment of a solver device according to the present disclosure.

FIG. 2 is a block diagram view of an embodiment of a solver device according to the present disclosure.

FIG. 3 is a flowchart showing an embodiment of a computer-implemented method capable of being performed, at least in part, by the solver device of FIG. 1 (e.g. when trained using the solver device of FIG. 2).

FIG. 4 shows an illustrative block diagram of an example embodiment of a computing environment that can be applied to implement embodiments of the present disclosure.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to”. Unless otherwise indicated, as used throughout this document, “or” does not require mutual exclusivity, and the singular forms “a”, “an” and “the” are intended to include the plural forms as well, unless the context clearly indicates otherwise.

An engine as referenced herein may comprise of software components such as, but not limited to, computer-executable instructions, data access objects, service components, user interface components, application programming interface (API) components; hardware components such as electrical circuitry, processors, and memory; and/or a combination thereof. The memory may be volatile memory or non-volatile memory that stores data and computer executable instructions. The computer-executable instructions may be in any form including, but not limited to, machine code, assembly code, and high-level programming code written in any programming language. The engine may be configured to use the data to execute one or more instructions to perform one or more tasks.

Inference embodiments of the disclosure include devices, systems, methods, and/or computer-readable mediums that include an agent engine, an encoder, a general-purpose solver engine, and an orchestrator coupled to the agent engine, the general-purpose solver engine, and the encoder. The orchestrator is configured to interact with the general-purpose solver engine and the encoder so that the encoder queries the agent engine for a best action based on a solver state, the agent engine is configured to determine the best action based on a learned policy, and the orchestrator is configured to direct the general-purpose solver engine based on the best action.

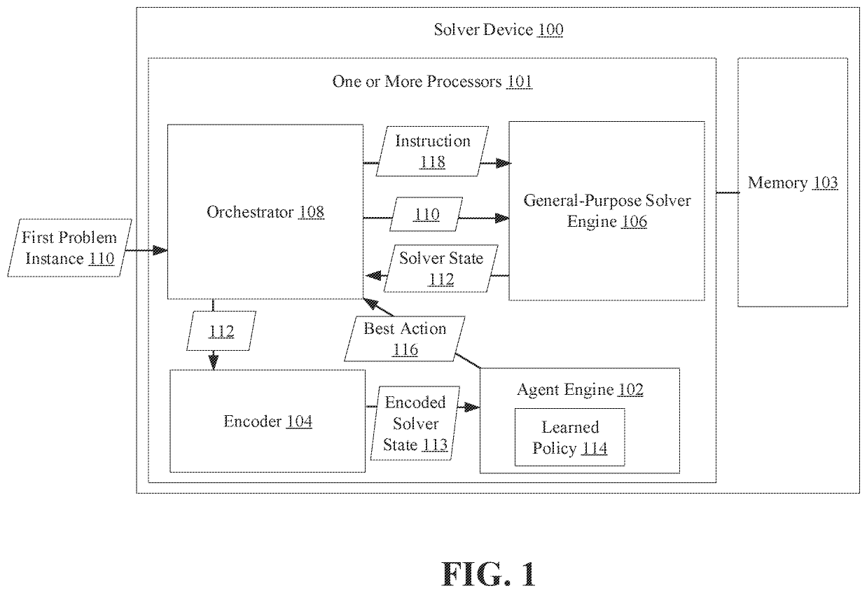

FIG. 1 illustrates an example embodiment of a solver device 100 that coordinates a solver process and incorporates agent logic in an optimization process. The solver device 100 illustrates example components of a solver used during an inference phase (e.g., after auto reinforcement learning training is performed to determine a learned policy 114) of the solver. The solver device 100 includes one or more processors 101 and a memory 103 coupled to the one or more processors 103. The one or more processors 101, in conjunction with the memory 103 (e.g., instructions stored in/on the memory), are configured to implement an agent engine 102, an encoder 104, a general-purpose solver engine 106, and an orchestrator 108 coupled to the agent engine 102, the encoder 104, and the general-purpose solver engine 106.

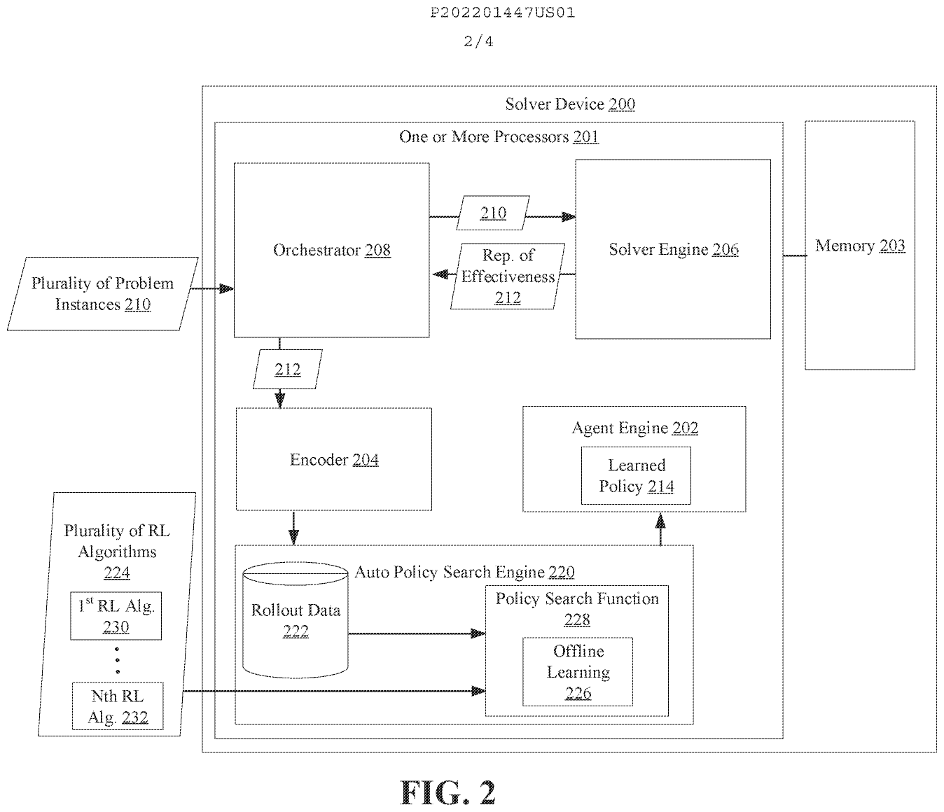

The orchestrator 108 is configured to receive a first problem instance 110 corresponding to the learned policy 114 that is based on auto reinforcement learning. The first problem instance 110 is an instance of a mathematical model (defined by an objective function, decision variables and constraints) for a realization of data. In some examples, the problem instance 110 is in the form of a mixed integer program. The learned policy 114 is a reinforcement learning algorithm that is learned or selected for one or more solver related tasks. The learned policy 114 may include tuning of one or many hyperparameters of the general-purpose solver engine 106 (such as, for example, which exploration strategy or feasibility-optimality tradeoff) or may be a policy for determining which branching variable to use at each step of the general-purpose solver engine 106, and is based on auto reinforcement learning. Any auto reinforcement learning technique can be used to determine the learned policy 114. As described in more detail below with reference to FIG. 2, the learned policy 114 of FIG. 1 is determined during a training phase.

Again with reference to FIG. 1, the orchestrator 108 is further configured to provide the first problem instance 110 to the general-purpose solver engine 106. The general-purpose solver engine 106 is a program that solves a range of mathematical optimization problems including linear programs and mixed-integer programs. The general-purpose solver engine 106 takes as input a definition of a mathematical optimization problem, i.e., a model. A model consists minimally of an objective function, decision variables, and sets of constraints. The aim of the general-purpose solver engine 106 is to determine the value of decision variables that maximize a stated objective. A model instance is an instantiation of the model with specific data. Once defined, the general-purpose solver engine 106 is configured to run an optimization algorithm and to returns the optimal objective function value and associated decision variables. As some examples, the general-purpose solver engine 106 may be international business machines (IBM®) ILOG CPLEX, CVXPY, or SCIP.

The general-purpose solver engine 106 is configured to execute based on the first problem instance 110. During execution the solver state 112, which captures attributes of the general-purpose solver engine 106 during the solution process, is determined. In some examples, the solver state 112 includes a number of fixed variables and a depth of a search tree.

The orchestrator 108 is configured to extract, from the general-purpose solver engine 106, the solver state 112, and provide the solver state 112 to the encoder 104.

The encoder 104 is configured to encode the solver state 112 to generate an encoded solver state 113 and to query the agent engine 102 for a best action 116 according to the learned policy 114. The encoded solver state 113 is a learnt representation of the solver state 112 and is used for training and inference of the learned policy 114. In some examples, the encoder 104 is configured to encode the solver state 112 by generating a fixed length embedding or a graph representation of the solver state 112 using any technique. In some examples, the best action 116 corresponds to one or more branching policies. In some examples, the encoder 104 is configured to query the agent engine 102 by sending the agent engine 102 the encoded solver state 113.

The agent engine 102 is configured to determine the best action 116 according to the learned policy 114 and the encoded solver state 113. In an example in which the solver state 112 includes the number of fixed variables and the depth of the search tree and the best action 116 corresponds to one or more branching policies, the agent engine 102 may be configured to implement the learned policy 114 to use the number of fixed variables and the depth of the search tree to establish one or more variables to branch on. In this example, the best action 116 corresponds to the one or more variables to branch on that are established via the learned policy 114.

The orchestrator 108 is further configured to receive the best action 116 from the agent engine 102 and direct the general-purpose solver engine 106 to implement the best action 116. The orchestrator 108 may direct the general-purpose solver engine 106 to implement the best action 116 by sending the general-purpose solver engine 106 an instruction 118 to implement the best action 116. In the example in which the best action 116 corresponds to the one or more variables to branch on that are established via the learned policy 114, the orchestrator 108 is configured to direct the general-purpose solver engine 106 to implement the best action 116 at least in part by directing the general-purpose solver engine 106 to branch on the one or more variables. In this example, the instruction 118 may identify the one or more variables and may instruct the general-purpose solver engine 106 to branch on the one or more variables.

FIG. 2 illustrates an example embodiment of a solver device 200 for determining a learned policy 214 (which may correspond to the learned policy 114 of FIG. 1) that can be used during an inference phase. The solver device 200 includes one or more processors 201 and a memory 203 coupled to the one or more processors 203. The one or more processors 201, in conjunction with the memory 203 (e.g., instructions stored on the memory 203) are configured to implement an agent engine 202, an encoder 204, a general-purpose solver engine 206, an auto policy search engine 220 coupled to the encoder 204 and the agent engine 202, and an orchestrator 108 coupled to the agent engine 202, the encoder 204, and the general-purpose solver engine 206.

During the training phase, the orchestrator 208 is configured to receive a plurality of problem instances 210, and provide the plurality of problem instances 210 to the general-purpose solver engine 206 (which may correspond to the general-purpose solver engine 106 described above with reference to FIG. 1). The general-purpose solver engine 206 is configured to execute based on the plurality of problem instances 210 to determine representation of effectiveness 212 of the general-purpose solver engine 206 for the plurality of problem instances 210. In some examples, the representation of the effectiveness 212 of the general-purpose solver engine 206 corresponds to a respective solver state-action-reward for each respective instance of the plurality of problem instances 210.

The orchestrator 208 is configured to extract the representation of the effectiveness 212 of the general-purpose solver engine 206 for the plurality of problem instances 210 (e.g., the respective solver state-action-rewards for the plurality of problem instances 210), and provide the representation of the effectiveness 212 to the encoder 204. The encoder 204 is configured to encode the representation of the effectiveness 212 into rollout data 222 using any technique, and to provide the rollout data 222 to the auto policy search engine 220.

The auto policy search engine 220 is configured to receive the rollout data 222 (from the encoder 204) and a plurality of reinforcement learning algorithms 224 (e.g., N reinforcement learning algorithms including a first reinforcement learning algorithm 230 . . . an Nth reinforcement learning algorithm 232), determine (e.g., via a policy search function 228) a learned policy 214 from the plurality of reinforcement learning algorithms 224 (and comprising tuned hyperparameters) using the rollout data 222 and via offline learning 226. As an example, the auto policy search engine 220 may determine the first reinforcement learning algorithm 230 with tuned hyperparameters as the learned policy 214. In some examples, the auto policy search engine 220 is configured to employ a two-level limited discrepancy search technique, which at the first level selects a policy algorithm (e.g., the first reinforcement learning algorithm 230) from the plurality of reinforcement learning algorithms 224, and at the second level determines associated hyperparameters of the selected reinforcement learning algorithm. In some examples, the auto policy search engine 220 is configured to determine the learned policy 214 according to IBM's® automated decision optimization system called AutoDO.

The auto policy search engine 220 provides the learned policy 214 to the agent engine 202, which stores the learned policy 214 for use during an inference phase.

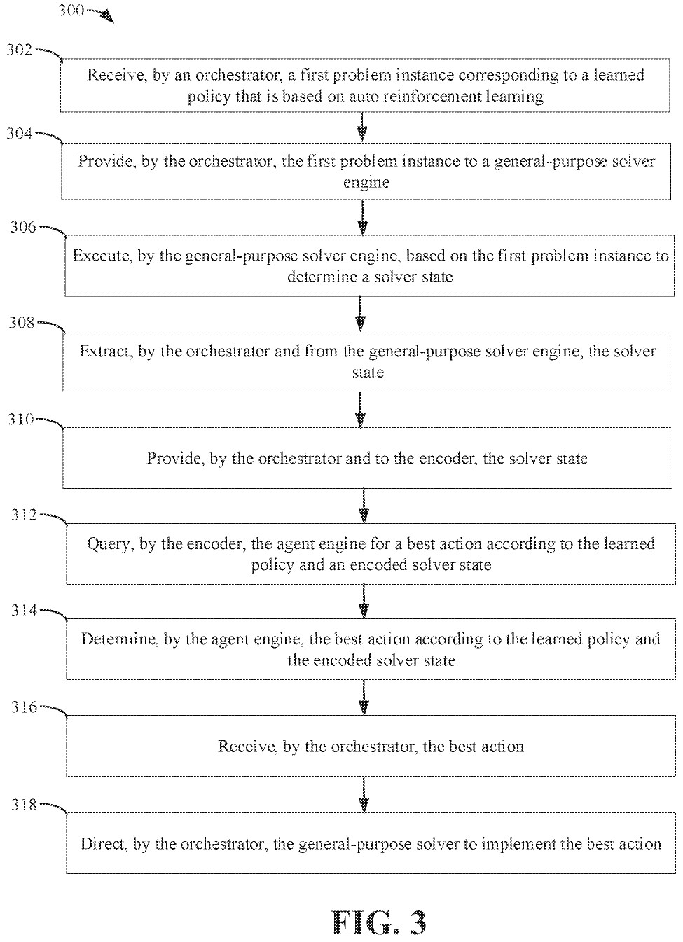

FIG. 3 illustrates an example flowchart of a computer-implemented method 300. The computer-implemented method 300 may be performed by the system 100 of FIG. 1 after being trained using the system 200 of FIG. 2.

The computer-implemented method 300 of FIG. 3 includes, at 302, receiving, by an orchestrator, a first problem instance corresponding to a learned policy that is based on auto reinforcement learning. For example, the orchestrator may correspond to the orchestrator 108 described above with reference to FIG. 1, the first problem instance may correspond to the first problem instance 110 described above with reference to FIG. 1, and the learned policy may correspond to the learned policy 114 described above with reference to FIG. 1.

In some examples, the learned policy of the computer-implemented method 300 is determined during a training phase as described above with reference to the learned policy 214 of FIG. 2. For example, the learned policy of the computer-implemented method 300 may be determined (as described above with reference to FIG. 2) at least in part by receiving, by an automated policy search engine, rollout data from the encoder; determining, by the automated policy search engine, the learned policy using the rollout data and via offline learning; and providing, by the automated policy search engine, the learned policy to the agent engine.

The computer-implemented method 300 of FIG. 3 further includes, at 304, providing, by the orchestrator, the first problem instance to a general-purpose solver engine. For example, the orchestrator 108 of FIG. 1 may provide the first problem instance 110 to the general-purpose solver engine 106 as described above with reference to FIG. 1.

The computer-implemented method 300 of FIG. 3 further includes, at 306, executing, by the general-purpose solver engine, based on the first problem instance to determine a solver state. For example, the general-purpose solver engine 106 of FIG. 1 may execute based on the first problem instance 110 of FIG. 1 to determine the solver state 112 of FIG. 1 as described above with reference to FIG. 1. In some examples, the solver state of the computer-implemented method 300 includes a number of fixed variables and a depth of the search tree as described above with reference to FIG. 1.

The computer-implemented method 300 of FIG. 3 further includes, at 308, extracting, by the orchestrator and from the general-purpose solver engine, the solver state. For example, the orchestrator 108 of FIG. 1 may extract the solver state 112 of FIG. 1 from the general-purpose solver engine 106 as described above with reference to FIG. 1.

The computer-implemented method 300 of FIG. 3 further includes, at 310, providing, by the orchestrator and to the encoder, the solver state. For example, the orchestrator 108 of FIG. 1 may provide the solver state 112 of FIG. 1 to the encoder 104 of FIG. 1 as described above with reference to FIG. 1.

The computer-implemented method 300 of FIG. 3 further includes, at 312, querying, by the encoder, the agent engine for a best action according to the learned policy and an encoded solver state. For example, the encoder 104 of FIG. 1 may provide the encoded solver state 113 of FIG. 1 to the agent engine 102 of FIG. 1 as described above with reference to FIG. 1.

The computer-implemented method 300 of FIG. 3 further includes, at 314, determining, by the agent engine, the best action according to the learned policy and the encoded solver state. For example, the agent engine 102 of FIG. 1 may determine the best action 116 of FIG. 1 according to the learned policy 114 and the encoded solver state 113 as described above with reference to FIG. 1. In some example, the best action 116 is one or more branching policies. In some examples, when the solver state of the computer-implemented method 300 of FIG. 1 includes a number of fixed variables to branch on and a depth of a search tree, the learned policy of the computer-implemented method 300 is configured to use the number of fixed variables and the depth of the search tree to establish one or more variables to branch on. In this example, the one or more branching policies include the one or more variables.

The computer-implemented method 300 of FIG. 3 further includes, at 316, receiving, by the orchestrator, the best action. For example, the orchestrator 108 of FIG. 1 may receive the best action 116 of FIG. 1 as described above with reference to FIG. 1.

The computer-implemented method 300 of FIG. 3 further includes, at 318, directing, by the orchestrator, the general-purpose solver engine to implement the best action. For example, the orchestrator 108 of FIG. 1 may direct the general-purpose solver engine 106 of FIG. 1 to implement the best action 116 of FIG. 1 as described above with reference to FIG. 1. As an example, the orchestrator 108 of FIG. 1 may send the general-purpose solver engine 106 of FIG. 1 the instruction 118 of FIG. 1. In some examples, directing the general-purpose solver engine to implement the best action includes the orchestrator directing the general-purpose solver engine to branch on the one or more variables.

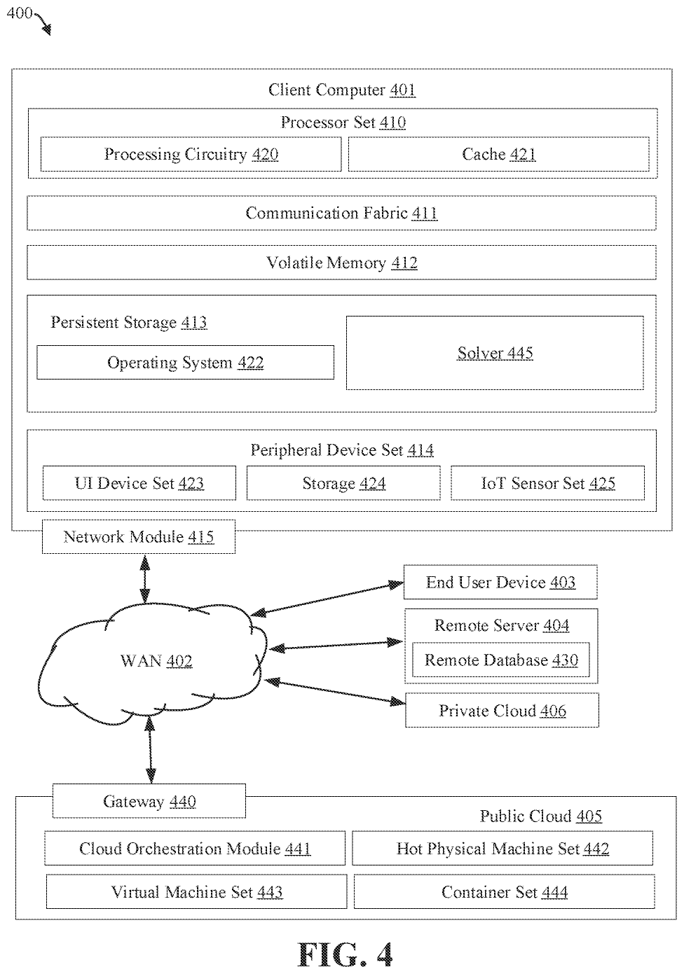

FIG. 4 illustrates an example embodiment of a computing environment 400. Computing environment 400 contains an example of an environment for the execution of at least some of the computer code involved in performing the inventive methods, such as solver 445. In addition to block 445, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 200, as identified above), peripheral device set 414 (including user interface (UI), device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 445 in persistent storage 413.

Communication Fabric 411 is the signal conduction paths that allow the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 412 is any type of volatile memory now known or to be developed in the future. Examples include dynamic type random access memory (RAM) or static type RAM. Typically, the volatile memory is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent Storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface type operating systems that employ a kernel. The code included in block 200 typically includes at least some of the computer code involved in performing the inventive methods.

Peripheral Device Set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network Module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote Server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public Cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

The flowchart and block diagrams in the FIGS. illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

What is claimed is:

1. A system, comprising:
an agent engine;
an encoder;
a general-purpose solver engine; and
an orchestrator coupled to the agent engine, the general-purpose solver engine, and the encoder and configured to:
receive a first problem instance corresponding to a learned policy that is based on auto reinforcement learning; and
provide the first problem instance to the general-purpose solver engine,
wherein the general-purpose solver engine is configured to execute based on the first problem instance to determine a solver state,
wherein the orchestrator is configured to:
extract, from the general-purpose solver engine, the solver state; and
provide the solver state to the encoder,
wherein the encoder is configured to query the agent engine for a best action according to the learned policy and an encoded solver state,
wherein the agent engine is configured to determine the best action according to the learned policy and the encoded solver state, and
wherein the orchestrator is configured to:
receive the best action; and
direct the general-purpose solver to implement the best action.

2. The system of claim 1, wherein the best action corresponds to one or more branching policies.

3. The system of claim 2, wherein the solver state comprises a number of fixed variables and a depth of a search tree.

4. The system of claim 3, wherein the learned policy is configured to use the number of fixed variables and the depth to establish one or more variables to branch on.

5. The system of claim 4, wherein the one or more branching policies comprise the one or more variables.

6. The system of claim 5, wherein the orchestrator being configured to direct the general-purpose solver to implement the best action comprises the orchestrator being configured to direct the general-purpose solver to branch on the one or more variables.

7. The system of claim 1, further comprising an automated policy search engine configured to:
receive rollout data from the encoder;
determine the learned policy using the rollout data and via offline learning; and
provide the learned policy to the agent engine.

8. A computer-implemented method, comprising:
receiving, by an orchestrator, a first problem instance corresponding to a learned policy that is based on auto reinforcement learning;
providing, by the orchestrator, the first problem instance to a general-purpose solver engine;
executing, by the general-purpose solver engine, based on the first problem instance to determine a solver state;
extracting, by the orchestrator and from the general-purpose solver engine, the solver state;
providing, by the orchestrator and to an encoder, the solver state;
querying, by the encoder, the agent engine for a best action according to the learned policy and an encoded solver state;
determining, by the agent engine, the best action according to the learned policy and the encoded solver state;
receiving, by the orchestrator, the best action; and
directing, by the orchestrator, the general-purpose solver engine to implement the best action.

9. The computer-implemented method of claim 8, wherein the best action corresponds to one or more branching policies.

10. The computer-implemented method of claim 9, wherein the solver state comprises a number of fixed variables and a depth of a search tree.

11. The computer-implemented method of claim 10, wherein the learned policy is configured to use the number of fixed variables and the depth to establish one or more variable to branch on.

12. The computer-implemented method of claim 11, wherein the one or more branching policies comprise the one or more variables.

13. The computer-implemented method of claim 12, wherein directing the general-purpose solver engine to implement the best action comprises the orchestrator directing the general-purpose solver engine to branch on the one or more variables.

14. The computer-implemented method of claim 13, further comprising:
receiving, by an automated policy search engine, rollout data from the encoder;
determining, by the automated policy search engine, the learned policy using the rollout data and via offline learning; and
providing, by the automated policy search engine, the learned policy to the agent engine.

15. A non-transitory computer-readable medium storing instructions that when executed by one or more processors, cause a solver device to:
receive, by an orchestrator of the solver device, a first problem instance corresponding to a learned policy that is based on auto reinforcement learning;
provide, by the orchestrator, the first problem instance to a general-purpose solver engine of the solver device;
execute, by the general-purpose solver engine, based on the first problem instance to determine a solver state;
extract, by the orchestrator and from the general-purpose solver engine, the solver state;
provide, by the orchestrator and to an encoder of the solver device, the solver state;
query, by the encoder, the agent engine for a best action according to the learned policy and an encoded solver state;
determine, by the agent engine, the best action according to the learned policy and the encoded solver state;
receive, by the orchestrator, the best action; and
direct, by the orchestrator, the general-purpose solver engine to implement the best action.

16. The non-transitory computer-readable medium of claim 15, wherein the best action corresponds to one or more branching policies.

17. The non-transitory computer-readable medium of claim 15, wherein the solver state comprises a number of fixed variables and a depth of a search tree.

18. The non-transitory computer-readable medium of claim 17, wherein the learned policy is configured to use the number of fixed variables and the depth to establish one or more variable to branch on.

19. The non-transitory computer-readable medium of claim 18, wherein the one or more branching policies comprise the one or more variables.

20. The non-transitory computer-readable medium of claim 19, wherein when executed by the one or more processors, the instructions are configured to direct the general-purpose solver engine to implement the best action by causing the orchestrator to direct the general-purpose solver engine to branch on the one or more variables.
